(19) United States
(12) Patent Application Publication
(10) Pub. No.: US 2025/0010132 A1
(43) Pub. Date: Jan. 9, 2025

(54) EVALUATION APPARATUS, EVALUATION METHOD, AND PROGRAM

(71) Applicant: NIPPON TELEGRAPH AND TELEPHONE CORPORATION, Tokyo (JP)

(72) Inventors: Daiki NASU, Tokyo (JP); Makio KASHINO, Tokyo (JP)

(73) Assignee: NIPPON TELEGRAPH AND TELEPHONE CORPORATION, Tokyo (JP)

(21) Appl. No.: 18/712,699

(22) PCT Filed: Nov. 30, 2021
(86) PCT No.: PCT/JP2021/043830

§ 371 Date: May 22, 2024

(51) Int. Cl. A63B 24/00; A63B 102/18

(52) U.S. Cl. CPC A63B 24/0003; A63B 2102/18; A63B 2220/05; A63B 2220/62; A63B 2220/806

(57) ABSTRACT

Provided is an evaluation apparatus and the like for evaluating a subject from a body motion of the subject and a behavior of an object accompanying the body motion of the subject. The evaluation apparatus evaluates, using time series data related to a body movement of a subject and time series data related to a behavior of an object accompanying the body movement, the subject on the basis of an error between a behavior of the object estimated from the body movement and an actual behavior of the object.

### TECHNICAL FIELD

The present invention relates to an evaluation apparatus, an evaluation method, and program for evaluating a subject.

### BACKGROUND ART

A baseball pitcher needs to throw pitches of various speeds, types, and trajectories in order to strike out a batter, and one batter needs to accurately predict the behavior of a ball reaching the batter's hand and hit the ball.

Non Patent Literature 1 proposes a method of measuring, analyzing, evaluating, and feeding back the behavior of a ball thrown by a pitcher.

Non Patent Literature 2 suggests that information about a pitcher's pitching form has an influence on the batter's prediction of the ball behavior.

### CITATION LIST

### Non Patent Literature

Non Patent Literature 1: “TRACKMAN FOR THOSE WHO KNOW HOW TO PRACTICE LIKE A PRO”, [online], [searched on Nov. 15, 2021], the Internet <URL: https://trackmanbaseball.com/> Non Patent Literature 2: Kimura, T., Nasu, D., & Kashino, M., “Utilizing Virtual Reality to Understand Athletic Performance and Underlying Sensorimotor Processing”, Proceedings 2018, 2 (6), 299

### SUMMARY OF INVENTION

### Technical Problem

In Non Patent Literature 1, the behavior of a thrown ball is merely evaluated, but as shown in Non Patent Literature 2, it is considered that a batter predicts the behavior of a ball using pitching form information and hits the ball. Therefore, it is necessary to evaluate a pitcher, including both the behavior of a ball and a pitching form. However, such an evaluation method has not been proposed.

An objective of the present invention is to provide an evaluation apparatus, an evaluation method, and a program for evaluating a subject (for example, a pitcher) from the body motion (for example, the pitching form) of the subject and the behavior (for example, the behavior of a ball) of an object accompanying the body motion of the subject.

### Solution to Problem

In order to solve the problem, according to one aspect of the present invention, an evaluation apparatus evaluates, using time series data related to the body movement of a subject and time series data related to the behavior of an object accompanying the body movement, the subject on the basis of an error between the behavior of the object estimated from the body movement and the actual behavior of the object.

### Advantageous Effects of Invention

According to the present invention, it is possible to evaluate a subject from the body motion of the subject and the behavior of an object accompanying the body motion of the subject.

### BRIEF DESCRIPTION OF DRAWINGS

FIG. 1 is a diagram for explaining results of a background experiment.

FIG. 2 is a functional block diagram of an evaluation system according to a first embodiment.

FIG. 3 is a diagram showing an example of a processing flow of the evaluation system according to the first embodiment.

FIG. 4 is a functional block diagram of a learning system according to a second embodiment.

FIG. 5 is a diagram showing an example of a processing flow of the learning system according to the second embodiment.

FIG. 6 is a diagram showing a configuration example of a computer to which the present method is applied.

### DESCRIPTION OF EMBODIMENTS

Hereinafter, embodiments of the present invention will be described. Note that, in the drawings to be used in the following description, components having the same functions or steps for performing the same processing will be denoted by the same reference numerals, and redundant description will be omitted. In the following description, the symbol “-” or the like used in the text would normally be notated immediately above the immediately preceding character, but is notated immediately after the character due to limitations of text notation. In formulas, these symbols are described in their original positions. In addition, processing performed in units of elements of a vector or a matrix is applied to all elements of the vector or the matrix unless otherwise specified.

### <Points of First Embodiment>

In the present embodiment, a pitcher is evaluated using an error between a ball speed predicted from a pitching form and an actual ball speed.

It has been reported that in order to predict the behavior (for example, ball speed) of a thrown ball and to hit the ball, a baseball batter uses not only the initial ball behavior but also pitching form information (for example, Non Patent Literature 2 and the like). However, only the behavior of the ball is used as a general evaluation index for a pitcher (Non Patent Literature 1), and there is no evaluation index using the relationship between the behavior of the ball and the pitching form.

In the present embodiment, a pitcher is evaluated using an error between the behavior of a ball predicted from a pitching form and the actual behavior of the ball. The larger the error, the more difficult it is to predict the ball behavior from the pitching form, that is, the more likely it is for the ball behavior to deviate from the prediction made by the batter. In this case, the more difficult it is to predict the ball behavior, the higher the evaluation of the pitcher becomes.

A particular point of the present embodiment is that the feature amount of a pitching form is calculated using the video photographed from the batter side, and the prediction is performed from the video viewed in the line of sight of the batter. It can be easily imagined that there is a relationship between the pitching form and the behavior of the ball. However, if the relationship is not conveyed to the batter as information, the game performance is not influenced. Therefore, by using the video in the line of sight of the batter, an evaluation index directly linked to the game performance can be obtained.

In the present embodiment, the level of difficulty of prediction about a pitcher's ball speed is evaluated from an error between the ball speed (estimated ball speed) estimated from movement video data and the actual ball speed on the basis of the finding that there is a correlation between the speed of the thrown ball and the feature amount acquired from the pitching form video (movement video data) photographed from the batter side.

First, description will be given of contents and results of experiments which serve as evidence for finding a correlation between the pitching form and the ball speed as a background of the present embodiment.

### [Background Experiment]

(i) A video is photographed from the batter side using a video camera when a pitcher pitches a straight ball a plurality of times (N times), and the ball speed is measured at that time by using a speed gun or the like. In the present embodiment, a straight ball is assumed as a target, but other pitch types may be assumed as a target. However, the same pitch type is assumed as a target. In this experiment, a video photographed from slightly behind a batter box (in the line of sight of the batter) is used. However, videos photographed from the position of a chief umpire or the net behind home plate (spectator stand) may be used. The point is to use the video photographed from the batter side (not from behind or beside the pitcher) in order to evaluate the level of difficulty of prediction made by the batter. In other words, time series data related to the motion of a subject (the pitcher) viewed from the subject's opponent (the batter) may be used.

(ii) A temporal analysis range and a spatial analysis range are determined in the acquired video.

For example, the temporal analysis range is set up to a time point (t1) going back by a predetermined time (for example, 300 ms) from a time point (t2) when the ball is released. t1 may be freely set as long as the time is until the ball release (t2). t1 may be an actual time (300 ms before the release or the like) as in this example, or may be a time point when a motion event is detected (a time point when the pitcher raises his or her foot). In this experiment, the setting was conducted so that the correlation of the results was maximized. The analysis time range is set up to the time point (t2) when the ball is released so that ball information is not included in optical flow to be described later.

In addition, for example, a horizontal width of the spatial analysis range is set to a half (W) of the mound width around the plate center, and a vertical width of the spatial analysis range is set to a half (H) of the mound width from a lower part of the mound. In short, a range including the entire pitching motion may be set as the spatial analysis range. In this experiment, the spatial analysis range is defined using the mound width, but may be limited to a part of the body (For example, a pitching arm or the like).

(iii) The feature amount of the optical flow of the pitching form is calculated from the photographed video. Note that the optical flow is a vector representing the motion of an object in temporally continuous digital images (photographed video). There are various conventional techniques as a method of calculating the optical flow, and any method may be used. Hereinafter, a method of calculating the feature amount of the optical flow will be described.

(1) An average value f (t) of the optical flow within a spatial analysis range at a certain time t is calculated from the following expression.

$$f ( t ) = \frac{\sum \vert {OF}_{t} \vert}{W \times H} \qquad [ Math . 1 ]$$

In this experiment, the average value is used, but other representative values may be used. For example, a median value, a sum, or the like can be used.

(2) f (t) is integrated in a temporal analysis range.

$$OF = {\int }_{t 1}^{t 2} f ( t ) dt \qquad [ Math . 2 ]$$

In this experiment, the integral is used, but other values may be used. For example, a maximum value within the temporal analysis range or the like can be used.

(3) An average value −OF is calculated of OF for each pitcher during N pitches. In this experiment, the average value is used, but other representative values may be used. For example, a median value or the like can be used.

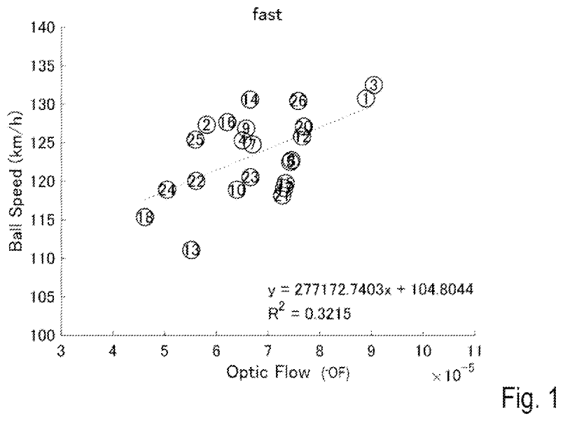

The results obtained in the above experiment are shown in FIG. 1. The numerical value in each circle in FIG. 1 represents an identification number of a target pitcher. From the results, it is found that there is a correlation between the ball speed and the feature amount of the optical flow of the pitching form photographed from the batter side.

### First Embodiment

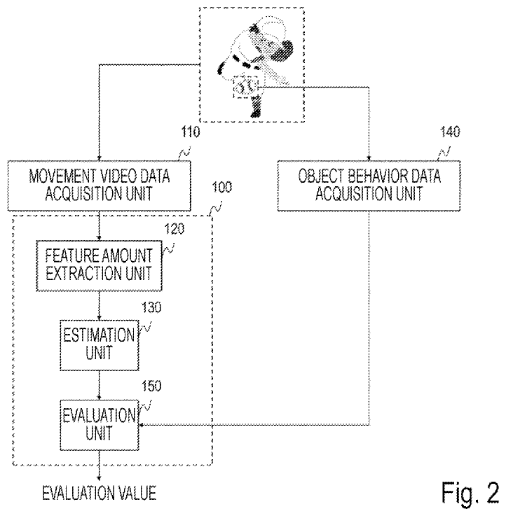

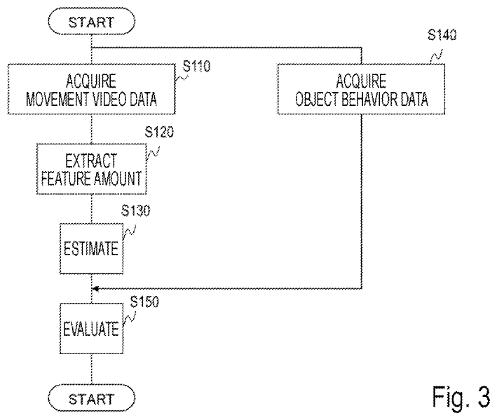

FIG. 2 is a functional block diagram of an evaluation system according to a first embodiment, and FIG. 3 shows a processing flow thereof.

The evaluation system includes an evaluation apparatus 100, a movement video data acquisition unit 110, and an object behavior data acquisition unit 140.

The evaluation apparatus 100 includes a feature amount extraction unit 120, an estimation unit 130, and an evaluation unit 150.

The movement video data acquisition unit 110 acquires movement video data by photographing the body motion of a subject. In this example, the movement video data acquisition unit 110 acquires the movement video data by photographing the movement (pitching) when the subject pitches a ball from the batter side.

The object behavior data acquisition unit 140 acquires the behavior of the object accompanying the body motion of the subject. In this example, the object behavior data acquisition unit 140 measures a pitch speed (actual ball speed) of the subject, and acquires object behavior data.

The evaluation apparatus 100 evaluates, using time series data related to the body movement of a subject and information about the actual behavior of an object accompanying the body movement, the subject on the basis of an error between the behavior of the object estimated from the body movement and the actual behavior of the object, and outputs an evaluation value. The movement video data acquired by photographing the body motion of the subject is used as the time series data related to the body movement of the subject, and the pitch speed (actual ball speed) acquired by the object behavior data acquisition unit 140 is used as the information related to the actual behavior of the object accompanying the body movement. In the present embodiment, the evaluation apparatus 100 estimates the ball speed from the video data about the pitcher's movement, calculates the level of difficulty of prediction about the pitcher's ball speed by using the error between the estimated ball speed and the actual ball speed, and evaluates the pitcher on the basis of the level of difficulty of prediction about the ball speed.

The evaluation apparatus 100 and a learning apparatus 200 to be described later are special devices configured by loading a special program into a known or dedicated computer including, for example, a central processing unit (CPU) and a main memory (random access memory (RAM)). The evaluation apparatus 100 and the learning apparatus 200 perform each processing under the control of the central processing unit, for example. Data input to the evaluation apparatus 100 and the learning apparatus 200 and data obtained in each processing are stored in the main memory, for example. The data stored in the main memory is read into the central processing unit and is used for other processes as necessary. At least one of the processing units in the evaluation apparatus 100 and the learning apparatus 200 may be configured by hardware such as an integrated circuit. Each storage unit included in the evaluation apparatus 100 and the learning apparatus 200 can be configured by, for example, the main memory such as a random access memory (RAM) or middleware such as a relational database or a key-value store. However, each storage unit is not necessarily included in the evaluation apparatus 100 or the learning apparatus 200. Each storage unit may be configured by an auxiliary memory including a semiconductor memory element such as a hard disk, an optical disk, or a flash memory and be provided outside the evaluation apparatus 100 and the learning apparatus 200.

Each of the units will be described below.

### <Movement Video Data Acquisition Unit 110>

The movement video data acquisition unit 110 outputs movement video data by photographing the movement when a subject pitches a ball from the batter side (S110). A commercially available video camera or the like may be used as a photographing device.

### <Feature Amount Extraction Unit 120>

The feature amount extraction unit 120 receives the movement video data as an input, and extracts (S120) and outputs the feature amount of the movement from the movement video data. In this example, the optical flow (hereinafter, also referred to as “OF”) of the pitching form is obtained from the images included in the movement video data, and the feature amount of the OF is calculated. The method of extracting the feature amount is performed in the same procedure as described in [Background Experiment]. One pitch thrown by a certain pitcher may be evaluated, or N pitches may be evaluated. For example, the feature amount is extracted by the following procedure.

First, a temporal analysis range and a spatial analysis range are determined in the acquired video.

Next, an average value f (t) of the optical flow within the spatial analysis range at a certain time t is calculated by the following expression.

$$f ( t ) = \frac{\sum \vert {OF}_{t} \vert}{W \times H} \qquad [ Math . 3 ]$$

Furthermore, f (t) is integrated in the temporal analysis range.

$$OF = {\int }_{t 1}^{t 2} f ( t ) dt \qquad [ Math . 4 ]$$

When one pitch is evaluated, this OF is defined as a feature amount. When N pitches are evaluated, OF of the N pitches is obtained, and a representative value (for example, average value −OF) thereof is defined as a feature amount.

### <Estimation Unit 130>

The estimation unit 130 receives the feature amount as an input, estimates (130) the behavior (in this example, ball speed) of an object accompanying the body motion of the subject from the feature amount by using a model, learned in advance to output a result of estimation of the behavior of the object accompanying the body motion of the subject from the body motion of the subject, and outputs the result of estimation. In this example, the model is learned in advance to output the result of estimation (estimated ball speed) of the ball speed with the feature amount extracted from the movement video data obtained by photographing the pitching form as an input. The learning method for model will be described in a second embodiment.

### <Object Behavior Data Acquisition Unit 140>

The object behavior data acquisition unit 140 acquires the behavior of the object accompanying the body motion of the subject (S140), and outputs object behavior data. For example, the object behavior data acquisition unit 140 is a device (a speed gun, a radar or video type ball trajectory measuring instrument, or the like) for measuring a pitch speed (actual ball speed) of the subject, and measures an actual ball speed as the object behavior data.

### <Evaluation Unit 150>

The evaluation unit 150 receives the result of estimation (in this example, estimated ball speed) of the estimation unit 130 and the object behavior data (in this example, actual ball speed) as an input, evaluates the subject on the basis of an error between the result of estimation and the object behavior data (S150), and outputs an evaluation value. In other words, the evaluation unit 150 calculates a higher evaluation as the deviation between the result of estimation of the estimation unit 130 and the object behavior data increases.

Here, the magnitude of the absolute value of the error is evaluated on the assumption that a general batter predicts the ball speed using the pitching form information. The larger the absolute value of the error, the larger the difference between the ball speed predicted from the pitching form and the actual ball speed, which means that the prediction is difficult. The more difficult it is to predict the ball speed, the harder it is for the batter to hit the ball, and thus the pitcher is highly evaluated. That is, the larger the deviation between the result of estimation and the object behavior data, the more difficult the prediction is, and the higher the subject is evaluated.

### <Effects>

With the above configuration, it is possible to evaluate the subject from the body motion of the subject and the behavior of the object accompanying the body motion of the subject.

### <Modifications>

In the present embodiment, the subject is a pitcher and the body movement is pitching. However, other games may also be targeted. The present embodiment is applicable not only to baseball but also to competition type ball games such as tennis, volleyball, table tennis, soccer, and basketball. The ball games referred to herein are competition type games using a sphere (ball) or its similar object, and the balls used in the ball games have various sizes, materials, and shapes. Here, the ball games also include rugby, badminton (bird called shuttlecock), ice hockey (puck), and the like. Furthermore, the present embodiment can be applied to any game in which the body movement of a subject and the behavior of an object accompanying the body movement can be estimated. Also in this case, the subject is evaluated on the basis of an error between the behavior of the object estimated from the body movement and the actual behavior of the object.

In the present embodiment, the time series data made from the feature amount of the optical flow is used as the time series data related to the body movement of the subject, but other time series data may be used as long as those are related to the body movement. For example, the optical flow itself, obtained from the moving image photographed by a video camera, may be used as the time series data related to the body movement of the subject, or time series data of the body movement acquired by image analysis of the moving image may be used. In addition, it is possible to use time series data of the body movement acquired by optical motion capturing, time series data of the body movement acquired by an acceleration sensor, and the like.

In addition, in any measurement method, full-body movement, movement of a pitching arm (a hand, wrist, forearm, or the like), movement of a pitching arm relative to a trunk, and the like can be targeted as the body movement, and as the movement mentioned here, a speed, an acceleration, a combination thereof, and the like can be used.

### Second Embodiment

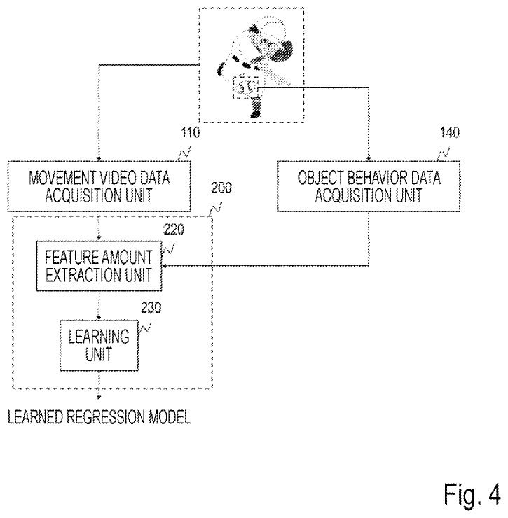

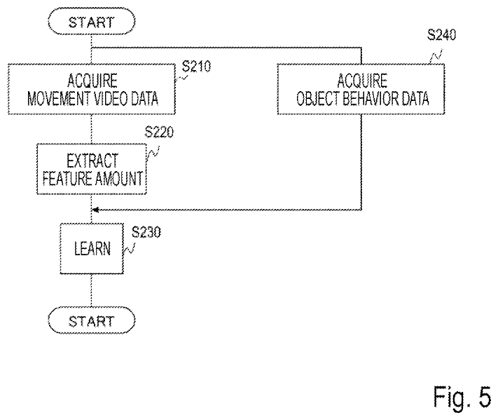

In the present embodiment, a learning system which learns the model constituting the estimation unit 130 in the evaluation apparatus 100 according to the first embodiment will be described. FIG. 4 is a functional block diagram of the learning system, and FIG. 5 shows an example of a processing flow thereof.

The learning system includes a learning apparatus 200, a movement video data acquisition unit 110, and an object behavior data acquisition unit 140.

The learning apparatus 200 includes a feature amount extraction unit 220 and a learning unit 230.

The learning apparatus 200 receives learning data as an input, learns a regression model using the learning data, and outputs the learned regression model.

Hereinafter, processing of each unit will be described.

In order to obtain the learning data, a plurality of subjects previously perform the pitching motion a plurality of times.

<Movement Video Data Acquisition Unit 110 and Object Behavior Data Acquisition Unit 140>

The movement video data acquisition unit 110 photographs the subject who performs the pitching motion to acquire movement video data for learning (S210), and the object behavior data acquisition unit 140 measures (S240) and outputs the actual ball speed for learning. The configurations of the movement video data acquisition unit 110 and the object behavior data acquisition unit 140 are the same as those in the first embodiment.

### <Feature Amount Extraction Unit 220>

The feature amount extraction unit 220 receives the movement video data for learning acquired by the movement video data acquisition unit 110 as an input, and extracts (S220) and outputs the feature amount of the pitching form from the images included in the movement video data in the same manner as in the feature amount extraction unit 120. The method of extracting the feature amount is the same as that in the feature amount extraction unit 120. A set of learning data including a set of the obtained feature amount and the actual ball speed is created.

### <Learning Unit 230>

The learning unit 230 receives the set of learning data as an input, and learns (S230) and outputs a model for estimating the behavior of the object accompanying the body movement from time series data related to the body movement of the subject. In the present embodiment, the model receives the feature amount extracted from the movement video data as an input, and outputs a result of estimation of the ball speed (estimated ball speed). In this example, a single regression model (see FIG. 1) in which the feature amount in the learning data is X and the actual ball speed is Y is learned.

### <Effects>

With such a configuration, it is possible to learn the model used in the first embodiment, which receives the feature amount as an input and outputs an estimated value of the object behavior.

### <Modifications>

In the present embodiment, the single regression model is learned, but any model may be learned as long as it is a model for estimating the behavior of the object accompanying the body movement from the time series data related to the body movement of the subject. For example, the behavior of the estimation target may include a pitch type, a trajectory, the rotation speed of a ball, the inclination of the rotation axis of the ball, and the like in addition to the ball speed. The model may be a model other than the single regression model, a neural network model, or the like. For example, the neural network model can be learned by machine learning or the like using learning data with the actual behavior as a correct answer.

### <Other Modifications>

The present invention is not limited to the above embodiments and modifications. For example, various kinds of processing described above may be executed not only in time series in accordance with the description but also in parallel or individually in accordance with processing abilities of the devices that execute the processing or as necessary. In addition, modifications can be made as needed within the gist of the present invention.

### <Program and Recording Medium>

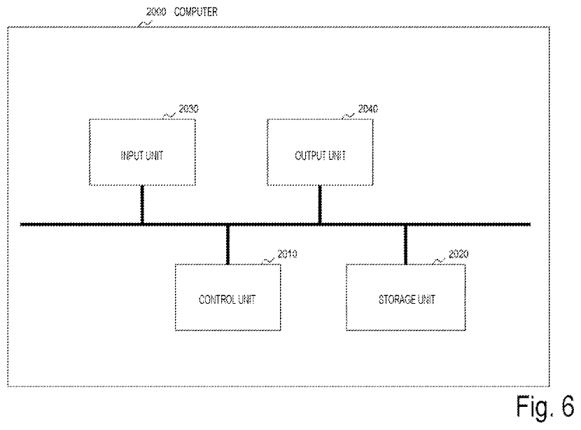

The above various kinds of processing can be implemented by loading a program for executing each step of the foregoing method to a storage unit 2020 of a computer shown in FIG. 6 and operating a control unit 2010, an input unit 2030, an output unit 2040, and the like.

The program in which the processing content is written may be recorded on a computer-readable recording medium. The computer-readable recording medium may be, for example, any recording medium such as a magnetic recording device, an optical disk, a magneto-optical recording medium, or a semiconductor memory.

In addition, the program is distributed by, for example, selling, transferring, or renting a portable recording medium such as a DVD or a CD-ROM on which the program is recorded. Further, a configuration may also be employed in which the program is stored in a storage device of a server computer and the program is distributed by transferring the program from the server computer to other computers via a network.

For example, a computer that executes such a program first temporarily stores a program recorded on a portable recording medium or a program transferred from the server computer in a storage device of the computer. Then, when executing processing, the computer reads the program stored in the recording medium of the computer and executes the processing according to the read program. In addition, as another mode of the program, the computer may read the program directly from the portable recording medium and execute processing according to the program, or alternatively, the computer may sequentially execute processing according to a received program every time the program is transferred from the server computer to the computer. In addition, the above-described processing may be executed by a so-called application service provider (ASP) type service that implements a processing function only by an execution instruction and result acquisition without transferring the program from the server computer to the computer. Note that the program in the present embodiment includes information that is used for processing by an electronic computer and is equivalent to the program (data or the like that is not a direct command to the computer but has property that defines processing performed by the computer).

In addition, although the present devices are each configured by executing a predetermined program on a computer in the present embodiments, at least part of the processing content may be implemented by hardware.

1. An evaluation apparatus which evaluates, using time series data related to a body movement of a subject and time series data related to a behavior of an object accompanying the body movement, the subject on the basis of an error between a behavior of the object estimated from the body movement and an actual behavior of the object.

2. The evaluation apparatus according to claim 1, wherein the time series data related to the body movement of the subject is time series data related to a motion of the subject viewed from a subject's opponent.

3. The evaluation apparatus according to claim 1, comprising:
processing circuitry configured to:
estimate the behavior of the object accompanying the body movement from the time series data related to the body movement of the subject; and
calculate a higher evaluation as a deviation between the estimated behavior of the object and the actual behavior of the object increases.

4. The evaluation apparatus according to claim 1, wherein the movement performed by the subject is a competition type ball game, and the object is a ball used in the ball game.

5. An evaluation method using an evaluation apparatus, wherein the evaluation apparatus evaluates, using time series data related to a body movement of a subject and time series data related to a behavior of an object accompanying the body movement, the subject on the basis of an error between a behavior of the object estimated from the body movement and an actual behavior of the object.

6. A non-transitory computer-readable recording medium having recorded thereon a program for causing a computer to function as the evaluation apparatus according to claim 1.
